(19) United States
(12) Patent Application Publication
(10) Pub. No.: US 2006/0279563 A1
(43) Pub. Date: Dec. 14, 2006

(54) METHOD FOR CALIBRATING FLAT PANEL DISPLAY

(76) Inventors: Yu-Chuan Shen, Hsinchu County (TW); Wei-Che Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,114

(22) Filed: Aug. 29, 2005

(30) Foreign Application Priority Data
Jun. 13, 2005 (TW) 94119460

(51) Int. Cl. G09G 5/00

(52) U.S. Cl. 345/207

(57) ABSTRACT

A method for calibrating a flat panel display comprising the following steps is provided. First, initialize a flat panel display and an optical meter. Provide a predetermined period of delay. Use the flat panel display to display a test pattern. Provide another predetermined period of delay. Use the optical meter to get measured data from the test pattern repeatedly until enough data for analysis is gathered. Repeat the step of displaying the test patterns until all test patterns have been displayed. Finally, analyze all the measured data to calculate the correct parameters for the control circuit of the flat panel display and set the parameters of the control circuit to the correct values.

### CROSS-REFERENCE TO RELATED APPLICATION

This application claims the priority benefit of Taiwan application serial no. 94119460, filed on Jun. 13, 2005. All disclosure of the Taiwan application is incorporated herein by reference.

### BACKGROUND OF THE INVENTION

1. Field of the Invention

The present invention relates to a method for calibrating a flat panel display. More particularly, the present invention relates to a method for calibrating and setting the control circuit parameters of a flat panel display.

A flat panel display including the thin film transistor liquid crystal

2. Description of the Related Art

Display (TFT LCD) is built using a number of optical, chemical and circuit components. There are quite a number of factors that affects the display characteristics such as brightness and color. For example, factors that affect a controller circuit include the video decoder, the de-interlacing circuit and the noise filter. Factors that affect the LCD module include the source of backlight, the thin film transistors and the color filters. If the properties of individual components are not carefully monitored in mass production, the display quality of the final products may vary considerably. To produce end products within an acceptable quality range, the manufacturers have to perform proper calibrations. When the product is not calibrated or improperly calibrated, some obvious side effects will appear, which include color bias, color temperature error, low contrast and/or gray bias, for example.

FIG. 1 is a flowchart showing the steps in a conventional calibration. First, in step 102, the test pattern is display. Then, in step 104, an optical meter is used to obtain measured data. In step 106, the measured data is analyzed. Thereafter, in step 108, the correct parameters for the control circuit are calculated and the parameters in the control circuit area adjusted accordingly. Finally, in step 110, the calibration is checked to see if it is completed. If there is a need for further calibration, the entire process starting from the step 102 is repeated, otherwise, the flow ends.

The conventional calibration method has a number of defects. For example, each test pattern is measured only once so that errors occur with a higher frequency. Moreover, there is no delay before displaying the test pattern in step 102 and before obtaining the measured data in step 104. Hence, the unstable transient states of the flat display and the optical meter can lead to errors. Besides, if multiple types of test patterns or a multiple of measurements on the same pattern is required, the tedious procedure that includes displaying the test pattern, performing the measurement and analysis and adjusting the parameters has to be repeated many times. As a result, there is considerable waste of equipment and labor time.

### SUMMARY OF THE INVENTION

Accordingly, at least one objective of the present invention is to provide a method for calibrating a flat panel display having the advantage of securing the measured data of multiple test patterns before analyzing the collection and adjusting all the parameters in a single operation. Hence, the calibration rate is increased and the timing cost is reduced.

At least a second objective of the present invention is to provide a method for calibrating a flat panel display capable of performing multiple measurements on the same test pattern and analyzing the collected data to reduce possible errors.

At least a third objective of the present invention is to provide a method for calibrating a flat panel display having the advantage of providing a delay period before displaying the test pattern and before obtaining the measured data. Hence, any transient instability in the flat panel display and the measuring optical meter is damped down to prevent possible errors.

At least a fourth objective of the present invention is to provide a method for calibrating a flat panel display that includes all three aforementioned advantages.

To achieve these and other advantages and in accordance with the purpose of the invention, as embodied and broadly described herein, the invention provides a method for calibrating a flat panel display comprising the following steps. (a) Use a flat panel display to display a plurality of test patterns and measure the aforementioned test patterns to obtain measured data; and, (b) set the parameters of the control circuit of the flat panel display according to the measured data.

The present invention also provides an alternative method of calibrating a flat panel display comprising the following steps. (a) Use the flat panel display to display a plurality of test patterns; (b) measure the test pattern repeatedly to obtain measured data until sufficient measured data is collected; and (c) set the parameters of the control circuit of the flat panel display according to the measured data.

The present invention also provides another method of calibrating a flat panel display comprising the following steps. (a) Initialize the flat panel display and an optical meter; (b) provide a predetermined delay period; (c) use the flat panel display to display a test pattern; (d) provide another predetermined delay period; (e) use the optical meter to obtain a measured data from the test pattern; and finally, (f) set the parameters of the control circuit of the flat panel display according to the measured data.

The present invention also provides yet another method of calibrating a flat panel display comprising the following steps. (a) Initialize the flat panel display and an optical meter; (b) provide a predetermined delay period; (c) use the flat panel display to display a test pattern; (d) provide another predetermined delay period; (e) use the optical meter to obtain measured data from the test pattern repeatedly; (f) check whether all the test patterns have been displayed; (g) if there are patterns still not displayed, return to step (c) to display the next test pattern; and finally, (h) set the parameters of the control circuit of the flat panel display according to the measured data.

In the preferred embodiment of the present invention, the method for calibrating a flat panel display includes performing a multiple of measurements on the same test pattern and analyzing the collected data to reduce errors. In addition, the present invention also opts for measuring and collecting the data of a multiple of test patterns before performing an analysis collectively to adjust all parameters in a single operation. Since there is no need for repeated analysis and adjustment, the calibration process is speeded up and the time cost is reduced. Furthermore, the setting of a delay period before displaying the test pattern and before capturing the measured data to wait out the transient fluctuation in the flat panel display and the optical meter results in less errors due to possible instability in the flat panel display and the optical meter.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart showing the steps in a conventional calibration.

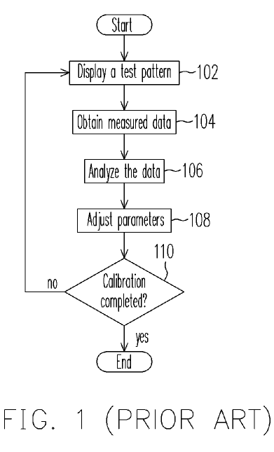

FIG. 2 is a hardware flowchart for showing the method of calibrating a flat panel display according to one embodiment of the present invention.

FIG. 3 is a flowchart showing the steps for calibrating a flat panel display according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

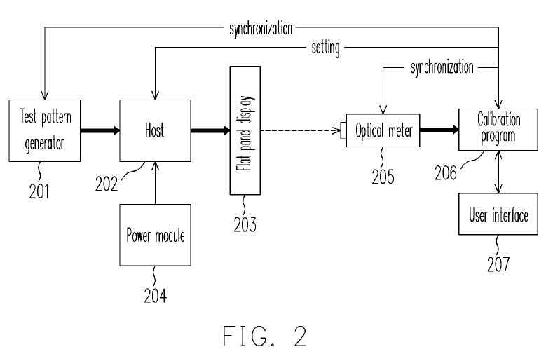

FIG. 2 is a hardware flowchart for showing the method of calibrating a flat panel display according to one embodiment of the present invention. In the present embodiment, a calibration program 206 receives instructions from an operator working through a user interface 207 so that the entire calibration process is under user control. First, a test pattern generator 201 generates a test pattern to a host 202. The host 202 receives power from a power module 204 and drives the flat panel display 203 to display the test pattern. Thereafter, an optical meter 205 measures the displayed test pattern on the flat panel display 203 and captures various data. Finally, the calibration program 204 collects the measured data, performs an analysis and sets all the parameters of the control circuit of the flat panel display 203 to the correct values.

In general, a flat panel display has a number of display characteristics that needs to be calibrated including brightness, color, texture display and so on. According to the type of display characteristics, the flat panel display 203 will display different types of test patterns, the optical meter 205 will produce different measured data and ultimately, the adjustment and setting received by the control circuit parameters will be different. In the present embodiment, the types of test patterns include at least total darkness, total brightness, a complete spectrum of gray scales, a complete spectrum of red, a complete spectrum of green, a complete spectrum of blue, skin colors, sky blue, grass green, various combinations of texture arrangements and dynamic images. The so-called ‘complete spectrum’ refers to all the colors of a color system from the lowest to the highest gray scale values.

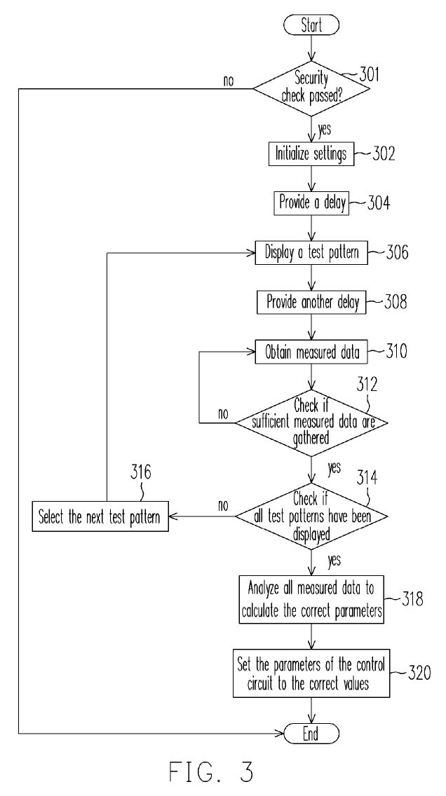

FIG. 3 is a flowchart showing the steps for calibrating a flat panel display according to one embodiment of the present invention. First, in step 301, the security check of the calibration program is executed. Here, the security check can include a variable number of checking items all depending on the need of the user. For example, the password inputted by the user may be verified, the presence or absence of the anti-copying device (for example, the Key Pro) may be checked and some other inspections. If the calibration program needs to work with a specified hardware, for example, must be executed in an embedded system, the aforementioned security check may include checking for the correctness of the hardware serial number and the correctness of the stored hardware keying data (for example, a predetermined identification word or code). After passing the security check in step 301, step 302 is executed. Conversely, if any one item in the list of security check(s) fails, the process flow is immediately terminated.

After passing the security check, the flat panel display and the optical meter are initialized in step 302. After a predetermined delay period in step 304, a first test pattern is displayed on the flat panel display in step 306. After that, there is another predetermined delay period in step 308. Then, in step 310, the optical meter is used to obtain measured data from the test pattern. In step 312, the measured data of the test pattern is checked to determine if sufficient data is obtained. If insufficient data is gathered, the flow returns to step 310 to obtain more measured data. If sufficient data has already been gathered, step 314 is executed.

In step 314, a checking procedure is carried out to determine if all test patterns have been displayed. If there is still one or more test patterns waiting to be displayed, the next test pattern is selected in step 31 6 and then the control is returned to step 306 to display the test pattern. Conversely, if all the test patterns have already been displayed, step 318 will execute to analyze all measured data and calculate all the correct parameters for the control circuit of the flat panel display. Finally, in step 320, the parameters of the control circuit are set to the correct values found in step 318.

According to the aforementioned description of the present invention, the method for calibrating a flat panel display includes performing a multiple of measurements on the same test pattern and analyzing the collected data to reduce errors. In addition, the present invention also opts for measuring and collecting the data of a multiple of test patterns before performing an analysis collectively to adjust all parameters in a single operation. Hence, there is no need for repeated analysis and adjustment. As a result, the calibration process is speeded up and the time cost is reduced. Furthermore, the setting of a delay period before displaying the test pattern and before capturing the measured data to wait out the transient fluctuation in the flat panel display and the optical meter results in less errors due to possible instability in the flat panel display and the optical meter.

In addition, the present invention also provides a number of test patterns for calibrating a number of display characteristics, for example, brightness, color and texture, of a flat panel display. Furthermore, the present invention also targets the display characteristics of the calibration to collect the measured data and modifies the data analysis and calculation to set the control circuit parameters accordingly. Therefore, aside from adjusting the gain and the offset of prior techniques, the present invention is also capable of adjusting all other parameters of the control circuit so that the calibration is more complete.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for calibrating a flat panel display, comprising the steps of:
(a) displaying a plurality of test patterns through a flat panel display and obtaining measured data of these test patterns; and
(b) setting the parameters of a control circuit of the flat panel display according to the measured data.

2. The calibration method of claim 1, before step (a) further compring:
executing at least a security check; and
if the security check fails, then terminates the process of calibrating the flat panel display.

3. The calibration method of claim 2, wherein the security check is one of the following: checking whether the hardware serial number is correct or not, checking whether the stored hardware keying data is correct or not, checking whether the anti-copying device is present or absent and checking whether the password inputted by the user is correct or not.

4. The calibration method of claim 1, wherein the step (a) further comprises:
(a1) displaying a test pattern using the flat panel display;
(a2) obtaining measured data of the test pattern;
(a3) checking whether all test patterns have already been displayed; and
(a4) if there is still a test pattern remains to be displayed, return to step (a1) and display the next test pattern.

5. The calibration method of claim 4, wherein the measured data of the test pattern are obtained using an optical meter, and before the step (a1) the method for calibrating the flat panel display further includes:
initializing the flat panel display and the optical meter; and
waiting for the passage of a first predetermined delay period; and
between the step (a1) and the step (a2) further includes:
waiting for the passage of a second predetermined delay period.

6. The calibration method of claim 4, wherein the step (a2) further comprises:
(a21 ) obtaining the measured data of the test pattern;
(a22) checking whether sufficient measured data of the test pattern are gathered or not; and
(a23) if the measured data from the test pattern are still insufficient, return to step (a21) to obtain more measured data.

7. The calibration method of claim 1, wherein the step (b) further comprises:
(b1) analyzing all measured data to calculate the correct parameters for the control circuit; and
(b2) setting the parameters of the control circuit to the correct values found in step (b1).

8. The calibration method of claim 1, wherein the types of the test patterns include at least total darkness, total brightness, a complete spectrum of gray scales, a complete spectrum of red, a complete spectrum of green, a complete spectrum of blue, skin colors, sky blue, grass green, various combinations of texture arrangements and dynamic images.

9. A method for calibrating a flat panel display, comprising the steps of:
(a) displaying a test pattern through a flat panel display;
(b) obtaining measured data from the test pattern repeatedly until sufficient measured data have been collected; and
(c) setting the parameters of a control circuit of the flat panel display according to the measured data.

10. The calibration method of claim 9, before the step (a) further compring:
executing at least a security check; and
if the security check fails, then terminates the process for calibrating the flat panel display.

11. The calibration method of claim 9, wherein the security check is one of the following: checking whether the hardware serial number is correct or not, checking whether the stored hardware keying data is correct or not, checking whether the anti-copying device is present or absent and checking whether the password inputted by the user is correct or not.

12. The calibration method of claim 9, wherein the measured data of the test pattern are obtained using an optical meter, and before the step (a) the method for calibrating the flat panel display further includes:
initializing the flat panel display and the optical meter; and
waiting for the passage of a first predetermined delay period; and
between the step (a) and the step (b) further includes:
waiting for the passage of a second predetermined delay period.

13. The calibration method of claim 9, wherein the step (b) further comprises:
(b1) obtaining measured data of the test pattern;
(b2) checking whether sufficient measured data of the test pattern are gathered or not; and
(b3) if the measured data from the test pattern are still insufficient, return to step (b1) to obtain more measured data.

14. The calibration method of claim 9, between the steps (b) and (c) further comprising:
inspecting whether all test patterns have been displayed; and
if there is a test pattern remains to be displayed, return to step (a) and display the next test pattern.

15. The calibration method of claim 9, wherein the step (c) further comprises:
(c1) analyzing all measured data to calculate the correct parameters for the control circuit; and
(c2) setting the parameters of the control circuits to the correct values found in step (c1).

16. The calibration method of claim 9, wherein the types of the test patterns include at least total darkness, total brightness, a complete spectrum of gray scales, a complete spectrum of red, a complete spectrum of green, a complete spectrum of blue, skin colors, sky blue, grass green, various combinations of texture arrangements and dynamic images.

17. A method for calibrating a flat panel display, comprising the steps of:
(a) initializing a flat panel display and an optical meter;
(b) providing a first predetermined delay period;
(c) displaying a test pattern using the flat panel display;
(d) providing a second predetermined delay period;
(e) using the optical meter to obtain measured data from the test pattern; and
(f) setting the parameters of a control circuit of the flat panel display according to the measured data.

18. The calibration method of claim 17, before the step (a) further comprising:
executing at least a security check; and
if the security check fails, then terminate the process for calibrating the flat panel display.

19. The calibration method of claim 18, wherein the security check is one of the following: checking whether the hardware serial number is correct or not, checking whether the stored hardware keying data is correct or not, checking whether the anti-copying device is present or absent and checking whether the password inputted by the user is correct or not.

20. The calibration method of claim 17, wherein the step (e) further comprises:
(e1) obtaining measured data of the test pattern;
(e2) checking whether sufficient measured data of the test pattern are gathered or not; and
(e3) if the measured data from the test pattern are still insufficient, return to step (e1) to obtain more measured data.

21. The calibration method of claim 17, between the steps (e) and (f) further comprising:
inspecting whether all test patterns have been displayed; and
if there is a test pattern remains to be displayed, return to step (c) and display the next test pattern.

22. The calibration method of claim 17, wherein the step (f) further comprises:
(f1) analyzing all measured data to calculate the correct parameters for the control circuit; and
(f2) setting the parameters of the control circuit to the correct values found in step (f1).

23. The calibration method of claim 17, wherein the types of the test patterns include at least total darkness, total brightness, a complete spectrum of gray scales, a complete spectrum of red, a complete spectrum of green, a complete spectrum of blue, skin colors, sky blue, grass green, various combinations of texture arrangements and dynamic images.

24. A method for calibrating a flat panel display, comprising the steps of:
(a) initializing a flat panel display and an optical meter;
(b) providing a first predetermined delay period;
(c) displaying a test pattern using the flat panel display;
(d) providing a second predetermined delay period;
(e) using the optical meter to obtain measured data from the test pattern repeatedly until sufficient measured data are gathered;
(f) checking whether all test patterns have been displayed;
(g) if there is a test pattern remains to be displayed, return to step (c) and display the next test pattern; and
(h) setting the parameters of a control circuit of the flat panel display according to the measured data.

25. The calibration method of claim 24, before the step (a) further comprising:
executing at least a security check; and
if the security check fails, then terminate the process for calibrating the flat panel display.

26. The calibration method of claim 25, wherein the security check is one of the following: checking whether the hardware serial number is correct or not, checking whether the stored hardware keying data is correct or not, checking whether the anti-copying device is present or absent and checking whether the password inputted by the user is correct or not.

27. The calibration method of claim 24, wherein the step (e) further comprises:
(e1) obtaining measured data of the test pattern using the optical meter;
(e2) checking whether sufficient measured data of the test pattern are gathered or not; and
(e3) if the measured data from the test pattern are still insufficient, return to step (e1) to obtain more measured data.

28. The calibration method of claim 24, wherein the step (h) further comprises:
(h1) analyzing all measured data to calculate the correct parameters for the control circuit; and
(h2) setting the parameters of the control circuits to the correct values found in step (h1).

29. The calibration method of claim 24, wherein the types of the test patterns include at least total darkness, total brightness, a complete spectrum of gray scales, a complete spectrum of red, a complete spectrum of green, a complete spectrum of blue, skin colors, sky blue, grass green, various combinations of texture arrangements and dynamic images.
